(19) United States
(12) Patent Application Publication
(10) Pub. No.: US 2009/0036304 A1
(43) Pub. Date: Feb. 5, 2009

(54) THERMOCHROMIC INK AND COATING COMPOSITIONS AND METHODS FOR THERMAL ACTIVATION

(75) Inventors: Matthew Jeremiah Misner, Scotia, NY (US); Ben Purushotam Patel, Niskayuna, NY (US); Marc Brian Wisnudel, Clifton Park, NY (US); Andrea Jeannine Peters, Clifton Park, NY (US); James Mitchell White, Niskayuna, NY (US); Kasiraman Krishnan, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/831,180

(22) Filed: Jul. 31, 2007

(51) Int. Cl. C09D 11/00

(52) U.S. Cl. 503/201; 106/31.32; 503/204

(57) ABSTRACT

A thermochromic ink composition comprises at least one thermochromic optical-state change material, at least one thermally responsive pH modifier, at least one solvent, and at least one binder material, wherein the thermochromic ink composition has a viscosity between about 0.1 centipoise (cPs) and about 10,000 cps, and a maximum optical absorbance in a range from about 200 nm (nanometers) to about 800 nm, and wherein the thermochromic ink composition is capable of transforming from a first optical state to a second optical state upon exposure to a thermal stimulus. The thermochromic ink composition may be used to deposit a thermochromic coating composition which may be used as part of an anti-theft system for optical articles. Methods for thermal activation of the compositions are also provided.

### BACKGROUND

The invention includes embodiments that relate to a thermochromic ink composition and a thermochromic coating composition. More particularly, the invention includes embodiments that relate to a thermochromic ink composition and a thermochromic coating composition for use as part of an anti-theft system for optical articles. Further, methods for thermal activation of the thermochromic ink composition and the thermochromic coating composition are also provided.

Shoplifting is a major problem for retail venues and especially for shopping malls, where it is relatively difficult to keep an eye on each customer while they shop or move around in the store. Relatively small objects, such as CDs and DVDs are common targets as they can be easily hidden and carried out of the shops without being noticed. Shops, as well as the entertainment industry, incur monetary losses because of such instances.

Even though closed circuit surveillance cameras may be located at such places, theft still occurs. Retail products sometimes are equipped with theft-deterrent packaging. For example, clothing, CDs, audiotapes, DVDs and other high-value items are occasionally packaged along with tags that set off an alarm if the item is removed from the store without being purchased. These tags are engineered to detect and alert for shoplifting. For example, tags that are commonly used to secure against shoplifting are the Sensormatic® electronic article surveillance (EAS) tags based on acousto-magnetic technology. RFID tags are also employed to trace the items on store shelves and warehouses. Other theft-deterrent technologies currently used for optical discs include hub caps for DVD cases that lock down the disc and prevent it from being removed from the packaging until it is purchased, and “keepers” that attach to the outside of the DVD case packaging to prevent the opening of the package until it is purchased. In some cases, retailers have resorted to storing merchandise in locked glass display cases. In other stores, the DVD cases on the shelves are empty, and the buyer receives the actual disc only when purchased. Many of these approaches are unappealing because they add an additional inconvenience to the buyer or retailer, or they are not as effective at preventing theft as desired. Optical storage media, in particular, pose an additional problem in that their packaging and the sensor/anti-theft tags may be easily removed.

Therefore, there is a continued need to provide techniques and systems that can assist in reducing the incidence of, and damage caused by, stolen media.

### BRIEF DESCRIPTION OF FIGURES

FIG. 1 shows voltage profiles and corresponding temperature profiles that may be used to activate the thermochromic coating according to an embodiment described herein.

### BRIEF DESCRIPTION

One embodiment of the invention is directed to a thermochromic ink composition comprising at least one thermochromic optical-state change material, at least one thermally responsive pH modifier, at least one solvent, and at least one binder material, wherein the thermochromic ink composition has a viscosity between about 0.1 centipoise (cPs) and about 10,000 cps, and a maximum optical absorbance in a range from about 200 nm (nanometers) to about 800 nm, and wherein the thermochromic ink composition is capable of transforming from a first optical state to a second optical state upon exposure to a thermal stimulus.

Another embodiment of the invention is directed to a thermochromic coating composition deposited using a thermochromic ink composition, wherein the thermochromic coating composition comprises at least one thermochromic optical-state change material, at least one thermally responsive pH modifier, and at least one binder material, wherein the thermochromic coating composition is essentially free of solvent, wherein the thermochromic coating composition has a maximum optical absorbance in a range from about 200 nm to about 800 nm and wherein the thermochromic coating composition is capable of transforming from a first optical state to a second optical state upon exposure to a thermal stimulus.

Another embodiment of the invention is directed to an article comprising a thermochromic coating composition deposited in or deposited on the article, wherein the thermochromic coating composition comprises at least one thermochromic optical-state change material, at least one thermally responsive pH modifier, and at least one binder material, wherein the thermochromic coating composition is essentially free of solvent, and wherein the thermochromic coating composition has an optical absorbance in a range from about 200 nm to about 800 nm and wherein the thermochromic coating composition is capable of transforming the article from a first optical state to a second optical state upon exposure to a thermal stimulus.

Another embodiment of the invention is directed to a method for transforming a thermochromic ink composition or a thermochromic coating composition from a first percent optical transmittance to a second percent optical transmittance, the method comprising the step of exposing the thermochromic ink composition or the thermochromic coating composition to a time-dependent thermal stimulus.

Another embodiment of the invention is directed to a method for changing the functionality of an optical article, comprising the steps of contacting a heating element to the optical article such that the heating element is in thermal contact with a thermochromic coating composition, sending an electrical signal from an activation device to the heating element, applying a time-dependent electrical current to the heating element, transferring heat from the heating element to the thermochromic coating composition resulting in a change in optical transmittance of the thermochromic coating composition, and transforming the optical article from a pre-activated state of functionality to an activated state of functionality, and removing the heating element from the optical article.

These and other advantages and features will be more readily understood from the following detailed description of preferred embodiments of the invention that is provided in connection with the accompanying drawing.

### DETAILED DESCRIPTION

One solution to this shoplifting problem, specifically for optical media articles such as DVD's, is to render at least a portion of the content of the DVD inaccessible unless the retailer at the point-of-sale has activated the DVD. One approach to rendering the content of the DVD inaccessible prior to activation is to employ a thermochromic ink composition to deposit a thermochromic coating composition in or on the DVD, wherein the thermochromic coating composition at least partially absorbs the incident laser from an optical data reader so that the complete data directly in the optical path of the laser cannot be read. In this instance, the optical article has no value, and therefore there is no incentive for the shoplifter to steal it. However, upon converting the DVD to an “activated” state using an external stimulus at the point-of-sale, the thermochromic coating composition becomes sufficiently transparent, with respect to the wavelength of the laser employed in the optical data reader, due to a change in the optical properties of the thermochromic coating composition, and the complete data directly in the optical path of the laser can now be read by the incident laser from the optical data reader, therefore rendering the full content of the DVD accessible to a legitimate consumer.

Various embodiments of thermochromic ink compositions, thermochromic coating compositions, articles comprising thermochromic coating compositions, and methods for activating the thermochromic ink and coating compositions are described below. Aspects of the embodiments described herein can be used in combination with the materials, systems and techniques previously disclosed in U.S. patent application Ser. Nos. 11/538,451 and 11/567,271, to inhibit the theft or unauthorized use of optical articles. Thus the disclosures of U.S. patent application Ser. No. 11/538,451, filed Oct. 4, 2006, and U.S. patent application Ser. No. 11/567,271, filed Dec. 6, 2006, are both hereby incorporated by reference in their entireties.

In one embodiment, a thermochromic ink composition includes at least one thermochromic optical-state change material, at least one thermally responsive pH modifier, at least one solvent, and at least one binder material, wherein the composition has a viscosity between about 0.1 cPs and about 10,000 cps, and a maximum optical absorbance in a range from about 200 nm to about 800 nm, and wherein the thermochromic ink composition is capable of transforming from a first optical state to a second optical state upon exposure to a thermal stimulus.

The term “thermochromic” as used herein, describes materials that undergo either a reversible or an irreversible thermally induced color change. As used herein the term “optical-state change” material is used to describe a material which is capable of existing in at least two different forms, each form possessing a unique optical state, for example a unique wavelength associated with a maximum optical absorbance within a range from about 200 nm to about 800 nm, or a unique extinction coefficient at a specific wavelength between about 200 nm to about 800 nm. Non-limiting examples of thermochromic optical-state change materials include halochromic optical-state change materials, thermochromic polymeric materials, thermochromic organic compounds, thermochromic hydrogels, liquid crystalline materials, leuco dyes, inorganic compounds such as, but not limited to, metal oxides and organometallic compounds, materials capable of undergoing a thermally initiated sigmatropic bond rearrangement, and thermally reactive adduct materials.

One suitable halochromic optical-state change material that may be used in the thermochromic ink composition is a chromic dye. As described herein the term “halochromic” describes a material which changes optical state for example, color, upon a change in pH i.e., a change in the acidity or basicity results in a change in the optical absorbance of the chromic dye. This process is also known as “acidicchromism” or “halochromism”. For example, the thermochromic ink composition may contain a thermochromic dye i.e., a pH responsive dye such as for example a triaryl methylene dye. One example of a triaryl methylene dye is the sodium salt of bromocresol green, which undergoes a change in its maximum optical absorbance from about 600 nm to about 650 nm at a pH value greater than about 7 to an optical absorbance below 450 nm at a pH values less than about 5. Within the scope of this disclosure the terms “pH” or “change in pH” are used to describe the acidity, basicity, or change in acidity or basicity of the thermochromic ink composition. A decrease in the pH is a result of an increase in acidity (or decrease in basicity) and an increase in the pH is a result of a decrease in acidity (or increase in basicity). In aqueous systems, pH values less than 7 are classified as acidic and pH values greater than 7 are classified as basic.

As used herein, the term “chromic dye” describes optical-state change dyes which can exist in two different color forms between about 200 nm to about 800 nm. In one embodiment, the chromic dye is a triarylmethylene dye. Suitable non-limiting examples of triarylmethylene dyes include bromocresol green, bromocresol purple, and corresponding salts thereof. Suitable examples of other chromic dyes are included in the listing of thermochromic dyes below.

Suitable thermochromic polymeric materials that may be used in the thermochromic ink composition include non-crosslinkable and crosslinkable homopolymers and copolymers doped with commercially available thermochromic dyes commonly known to those skilled in the art. Suitable non-limiting examples of polymeric materials include polyolefins, polyesters, polyamides, polyacrylates, polymethacrylates, polyvinylchlorides, polycarbonates, polysulfones, polysiloxanes, polyetherimides, polyetherketones, and blends, and copolymers thereof. In the case of non-crosslinked materials, the thermochromic dye can be added at various stages of polymer processing, including the extrusion stage. In the case of crosslinkable materials (for example, thermosetting plastics such as epoxies and crosslinked acrylate resins), the thermochromic dyes must be added during the production of the crosslinkable material.

Non-limiting examples of thermochromic dyes that can be used with the polymeric material include bromocresol green, bromocresol purple, bromophenol blue, thymolphthalein, thymol blue, aniline blue WS, durazol blue 4R, durazol blue 8G, magenta II, mauveine, naphthalene blue black, orcein, pontamine sky blue 5B, naphthol green B, picric acid, martius yellow, naphthol yellow S, alcian yellow, fast yellow, metanil yellow, azo-eosin, xylidine ponceau, orange G, ponceau 6R, chromotrope 2R, azophloxine, lissamine fast yellow, tartrazine, amido black 10B, bismarck brown Y, congo red, congo corinth, trypan blue, Evans blue, Sudan III, Sudan IV, oil red O, Sudan black B, Biebrich scarlet, Ponceau S, woodstain scarlet, Sirius red 4B, Sirius red F3B, fast red B, fast blue B, auramine O, malachite green, fast green FCF, light green SF yellowish, pararosanilin, rosanilin, new fuchsin, Hoffman's violet, methyl violet 2B, crystal violet, Victoria blue 4R, methyl green, ethyl green, ethyl violet, acid fuchsin, water blue I, methyl blue, chrome violet CG, chromoxane cyanin R, Victoria blue R, Victoria blue B, night blue, pyronin Y, pyronin B, rhodamine B, fluorescein, eosin Y ws, ethyl eosin, eosin B, phloxine B, erythrosin B, rose bengal, Gallein, acriflavine, acridine orange, primuline, thioflavine T, thioflavine S, safranin O, neutral red, azocarmine G, azocarmine B, safranin O, gallocyanin, gallamine blue, celestine blue B, nile blue A, thionin, azure C, azure A, azure B, methylene blue, methylene green, toluidine blue O, alizarin, alizarin red S, purpurin, anthracene blue SWR, alizarin cyanin BBS, nuclear fast red, alizarin blue, Luxol fast blue MBS, alcian blue 8GX, saffron, Brazilin and Brazilein, hematoxylin and hematein, laccaic acid, Kermes, and carmine.

In one embodiment, the thermally responsive pH modifier used in the thermochromic ink composition is a thermally responsive Bronsted acid or a thermally responsive Bronsted base. Suitable non-limiting examples of thermally responsive pH modifiers include one or more of sulfonic acid salts, phosphoric acid salts, hydrochloric acid salts, triflic acid salts, alkali metal salts, amine salts, ammonium salts, iodonium salts, and benzoic acid. Specific non-limiting examples of thermally responsive pH modifiers include dinonylnaphthalene sulfonate, dodecylbenzene sulfonate, p-toluenesulfonate, (4-phenoxyphenyl)diphenylsulfonium trifluoromethanesulfonate, bis(4-t-butylphenyl)iodonium p-toluenesulfonate, (4-t-butylphenyl)diphenlsulfonium triflate, triphenylsulfonium triflate, diphenyliodoniumhexafluorophosphate, ethyl p-toluenesulfonate, dipenyliodonium chloride, 4-octyloxyphenyl phenyl iodonium fluoroantimonate, ammonium hexafluoroantimonate, and ethyl benzoate. In general, the thermally responsive pH modifier is distinct from the non-thermally responsive pH modifier, and in one embodiment the non-thermally responsive pH modifier includes Bronsted acids or Bronsted bases.

In various embodiments, the solvents used in the thermochromic ink compositions are selected based on different parameters as discussed herein. In one embodiment, a suitable solvent may be selected to satisfy the solubility of various components in the thermochromic ink composition including the binder material, the halochromic optical-state change material, and the thermally responsive pH modifier. In another embodiment, wherein the thermochromic ink composition is used to deposit a thermochromic coating composition, the solubility of the different components of the thermochromic ink composition in the solvent should be such that there will be no phase separation of the different components during the post-deposition drying step. In a further embodiment, wherein the thermochromic ink composition is used to deposit a thermochromic coating composition on an article suitable solvents include those that exhibit a chemical inertness towards the material used to form the article. For example if the article is an optical article such as for example a DVD made using a polycarbonate, the selected solvent(s) should not induce solubilization, crystallization, or any other form of chemical or physical attack of the polycarbonate. This is essential to preserve the readability of the data underneath the thermochromic coating composition. In one embodiment, in the case of solvent mixtures the volume fraction of any solvent that could potentially attack the polycarbonate may be less than about 30 percent. As used herein the term “surface tension” refers to a property of the liquid that affects the spreading of a liquid on a surface. The surface tension will have a dramatic result on the final shape of a drop or multiple drops of liquid printed on solid surfaces. With respect to the ink formulations of the present disclosure, surface tension is a critical parameter for printing the ink formulations using conventional printing techniques such as, but not limited to, inkjet printing and screen printing. Surface tension is also a parameter for the jetting process itself during inkjet printing, as it will affect how drops are formed at the print-head. If the surface tension is not appropriate, inks will not be jettable with inkjet printing.

Other aspects of suitable solvents include, but are not limited to, low vapor pressure and high boiling points so that the thermochromic ink is printable by methods known to one skilled in the art, such as for example, screen printing or inkjet printing methods. Solvents with lower boiling points may evaporate rapidly from the ink, causing clogging of inkjet print head nozzles or drying onto a printing screen, either of which can lead to poor quality of the resultant thermochromic coating. In one embodiment, a solvent with a boiling point above 130° C. is preferred. In various embodiments, the thermochromic ink composition should be a physical mixture of the various components and there should be no reactivity between the components at least under ambient conditions.

In one embodiment, suitable solvents employed in the thermochromic ink composition include, but are not limited to: a glycol ether solvent, an aromatic hydrocarbon solvent containing at least 7 carbon atoms, an aliphatic hydrocarbon solvent containing at least 6 carbon atoms, a halogenated solvent, an amine based solvent, an amide based solvent, an oxygenated hydrocarbon solvent, or miscible combinations thereof. Some specific suitable non-limiting examples of such solvents include diacetone alcohol, dipropylene glycol methyl ether (Dowanol DPM), butyl carbitol, ethylene glycol, glycerol with glycol ethers, cyclohexanone, and miscible combinations thereof.

The primary function of the binder materials is to assist the adherence of a thermochromic ink composition to the surface of an article on which the thermochromic ink composition is deposited. Suitable non-limiting examples of binder materials include one or more of a polymer, an oligomer, a polymeric precursor, and a polymerizable monomer. Suitable non-limiting examples of polymeric materials include poly(alkenes), poly(anilines), poly(thiophenes), poly(pyrroles), poly(acetylenes), poly(dienes), poly(acrylates), poly(methacrylates), poly(vinyl ethers), poly(vinyl thioethers), poly(vinyl alcohols), poly(vinyl ketones), poly(vinyl halides), poly(vinyl nitriles), poly(vinyl esters), poly(styrenes), poly(arylenes), poly(oxides), poly(carbonates), poly(esters), poly(anhydrides), poly(urethanes), poly(sulfonates), poly(siloxanes), poly(sulfides), poly(thioesters), poly(sulfones), poly(sulfonamides), poly(amides), poly(ureas), poly(phosphazenes), poly(silanes), poly(silazanes), poly(benzoxazoles), poly(oxadiazoles), poly(benzothiazinophenothiazines), poly(benzothiazoles), poly(pyrazinoquinoxalines), poly(pyromellitimides), poly(quinoxalines), poly(benzimidazoles), poly(oxindoles), poly(oxoisoindolines), poly(dioxoisoindolines), poly(triazines), poly(pyridazines), poly(piperazines), poly(pyridines), poly(piperidines), poly(triazoles), poly(pyrazoles), poly(pyrrolidines), poly(carboranes), poly(oxabicyclononanes), poly(dibenzofurans), poly(phthalides), poly(acetals), poly(anhydrides), carbohydrates, blends of the above polymeric materials, and copolymers thereof. In one embodiment, the thermochromic ink composition comprises a polymerizable monomer, such as an acrylate monomer (e.g., methyl methacrylate), which can be polymerized (i.e. cured) to form a thermochromic coating after the thermochromic ink composition has been deposited on an optical article.

As described herein, the term “thermochromic ink composition” is used to describe a liquid composition comprising various components as described above. In one embodiment, the thermochromic ink composition has a viscosity in a range from about 0.1 cPs to about 10,000 cps. In another embodiment, the ink composition has a viscosity in a range from about 5 cPs to about 95 cPs. In yet another embodiment, the ink composition has a viscosity in a range from about 10 cPs to about 90 cPs. In various embodiments, the viscosity of the thermochromic ink composition may be tuned by controlling the concentration, such as for example the weight percent of the various components of the thermochromic ink composition, and/or by carefully controlling a particular property of a specific component of the thermochromic ink composition such as for example the molecular weight of the binder material.

As discussed above, the thermochromic ink composition is capable of transforming from a first optical state to a second optical state upon exposure to a thermal stimulus. The change from the first optical state to the second optical state occurs due to the presence of the thermochromic optical-state change material. In one embodiment, the thermochromic transformation from the first optical state to the second optical state is a bistable transformation. As used herein, the term “bistable transformation” is defined as a condition where the optical state of the thermochromic ink composition corresponds to one of two possible free energy minima and the ink composition remains in its current optical state in the absence of an external thermal stimulus above about 80° C. In one embodiment, the thermochromic ink composition is transformed from the first optical state to the second optical state in a temperature range from about 80° C. to about 200° C. In another embodiment, the thermochromic ink composition is transformed from the first optical state to the second optical state in a temperature range from about 90° C. to about 190° C. In yet another embodiment, the thermochromic ink composition is transformed from the first optical state to the second optical state in a temperature range from about 100° C. to about 180° C.

In another embodiment, the difference in the optical reflectivity of the ink composition between the first optical state and the second optical state is at least 10 percent. In yet another embodiment, the difference in the percent transmittance of the thermochromic optical-state change material between the first optical state and the second optical state is at least 10 percent.

In one embodiment, the thermochromic ink composition has a maximum optical absorbance in a range of about 200 nm to about 800 nm. In another embodiment, the thermochromic ink composition has a maximum optical absorbance in a range of about 300 nm to about 700 nm. In yet another embodiment, the thermochromic ink composition has a maximum optical absorbance in a range of about 400 nm to about 650 nm. It will be appreciated that the specific wavelengths for which the absorbance of the composition is maximized may be chosen to correspond to a particular application. For instance, if the composition is intended for use with DVD systems, the choice of wavelength should desirably correspond to the wavelengths in use in DVD players.

In one embodiment, the thermally responsive pH modifier may be encapsulated inside a temperature sensitive coating material. The temperature sensitive coating material serves to segregate the encapsulated component from additional components of the thermochromic ink composition. The temperature sensitive coating material is selected such that it can be melted, dissolved, or otherwise fractured at a particular temperature, thereby freeing the encapsulated component to interact with at least one additional component of the thermochromic ink composition. Suitable non-limiting examples of temperature sensitive coating materials include, aliphatic waxes, olefin waxes, paraffin waxes, saturated oils, unsaturated oils, and any carbon or silicon based polymeric material with a glass transition temperature below about 70° C. In another embodiment, the thermochromic optical-state change material may be encapsulated inside a temperature sensitive coating material. In yet another embodiment, a Bronsted acid may be encapsulated inside a temperature sensitive coating material. In still yet another embodiment, a Bronsted base may be encapsulated inside a temperature sensitive coating material.

In another embodiment the thermochromic ink composition further comprises at least one non-thermally responsive pH modifier. Suitable non-thermally responsive pH modifiers include either acids or bases. These acids may be of various types, including a mineral acid, an organic acid, a Lewis acid, a Bronsted acid, a superacid, and an acid salt. Suitable non-limiting examples of acids include acetic acid, trifluoroacetic acid, hydrochloric acid, nitric acid, sulfuric acid, benzoic acid, toluene sulfonic acid, ethanoic acid, oxalic acid, and citric acid. Examples of the types of bases include an organic base, a Lewis base, a Bronsted base, a superbase, and basic salts. Suitable non-limiting examples of bases include ammonia, triethylamine, methyl amine, cyclohexylamine, dicyclohexylamine, 1,8-bis(dimethylamino)naphthalene, 1,4-diazabicyclo[2.2.2]octane, pyridine, imidazole, potassium hydroxide, and sodium hydroxide.

In yet another embodiment, the thermochromic ink composition further comprises at least one anti-photobleaching agent. Photobleaching of the thermochromic coating composition may occur through either a photoinduced oxidation and/or a photothermal degradation process. The anti-photobleach agent is added to retard the photo-induced degradation of the thermochromic coating composition when exposed to either ultraviolet or visible light. Suitable non-limiting examples of anti-photobleach agents include, biphenol, mono-, di- and tri-hydroxy substituted aromatics (e.g., hydroquinone), and poly(hydroxystyrene). A general reference which describes various classes of anti-photobleach is F. Gugumus, “Light Stabilizers”, in Plastics Additives Handbook, 5th Ed., H. Zweifel, ed., Hanser Publishers, 2001, pp. 141-425. In one embodiment, biphenol, biphenol derivative, or combinations thereof effectively reduces photobleaching. General structural examples of suitable biphenol derivatives can be found in U.S. patent application Ser. No. 10/391,401, filed Mar. 18, 2003. Suitable non-limiting examples of biphenol and biphenol derivatives include 4,4′-biphenol, 3,3′-biphenol, 2,2′-biphenol, 2,2′,6,6′-tetramethyl-3,3′,5,5′-tetrabromo-4,4′-biphenol, 2,2′,6,6′-tetramethyl-3,3′,5-tribromo-4,4′-biphenol, 3,3′-dimethylbiphenyl-4,4′-diol, 3,3′-ditert-butylbiphenyl-4,4′-diol, 3,3′,5,5′-tetramethylbiphenyl-4,4′-diol, 2,2′-ditert-butyl-5,5′-dimethylbiphenyl-4,4′-diol, 3,3′-ditert-butyl-5,5′-dimethylbiphenyl-4,4′-diol, 3,3′,5,5′-tetratert-butylbiphenyl-4,4′-diol, 2,2′,3,3′,5,5′-hexamethylbiphenyl-4,4′-diol, 2,2′,3,3′,5,5′,6,6′-octamethylbiphenyl-4,4′-diol, 3,3′-di-n-hexylbiphenyl-4,4′-diol, 3,3′-di-n-hexyl-5,5′-dimethylbiphenyl-4,4′-diol, and the like.

In another embodiment, the present invention provides a thermochromic coating composition, deposited using a thermochromic ink composition, wherein the thermochromic coating composition comprises at least one thermochromic optical-state change material, at least one thermally responsive pH modifier, and at least one binder material, wherein the thermochromic coating composition is essentially free of solvent, wherein the thermochromic coating composition has a maximum optical absorbance in a range from about 200 nm to about 800 nanometers, and wherein the thermochromic coating composition is capable of transforming from a first optical state to a second optical state upon exposure to a thermal stimulus. In yet another embodiment, the present invention provides an article comprising the thermochromic coating composition deposited in or deposited on the article.

As used herein, the term “coating” describes a layered film structure. In certain embodiments, the layered film structure may comprise a single layer. In one embodiment, the thickness of the coating is in a range from about 0.1 micron to about 100 microns. In another embodiment, the thickness of the coating is in a range from about 5 micron to about 95 microns. In yet another embodiment, the thickness of the coating is in a range from about 10 micron to about 90 microns.

In one embodiment, the thermochromic coating composition may be deposited on an article using the thermochromic ink composition by employing methods known to one skilled in the art. For example, screen printing and ink-jet printing methods can be used. In one embodiment, the article is an optical article. The thermochromic ink composition may be converted to the corresponding thermochromic coating composition, using methods known to one skilled in the art. Exemplary methods include air drying at ambient conditions, drying under controlled temperature conditions such as for example in an oven, drying under vacuum, and the like.

As used herein, the term “essentially free of solvent” means that the thermochromic coating composition may contain less than about 0.1 weight percent of solvent based on the total weight of the thermochromic coating composition.

In various embodiments, the thermochromic optical-state change material, the thermally responsive pH modifier, the binder material, the non-thermally responsive pH modifier and the anti-photobleaching agent may be the same or similar to those discussed above for the thermochromic ink composition.

In one embodiment, the thermochromic coating composition has a maximum optical absorbance in a range of about 200 nm to about 800 nm. In another embodiment, the thermochromic coating composition has a maximum optical absorbance in a range of about 300 nm to about 700 nm. In yet another embodiment, the thermochromic coating composition has a maximum optical absorbance in a range of about 400 nm to about 650 nm. As discussed above, it will be appreciated that the specific wavelengths for which the absorbance of the composition is maximized may be chosen to correspond to a particular application.

As used herein, the term “optical article” refers to an article that includes an optical data layer for storing data. The stored data may be read by, for example, an incident laser of an optical data reader device such as a standard compact disc (CD) or digital versatile disc (DVD) drive, commonly found in most computers and home entertainment systems. In some embodiments, the optical article may include one or more data layers. Furthermore, the optical data layer may be protected by employing an outer coating, which is transparent to the incident laser light, and therefore allows the incident laser light to pass through the outer coating and reach the optical data layer. Non-limiting examples of optical articles include a compact disc (CD); a digital versatile disc (DVD); multi-layered structures, such as DVD-5 or DVD-9; multi-sided structures, such as DVD-10 or DVD-18; a high definition digital versatile disc (HD-DVD); a Blu-ray disc; a near field optical storage disc; a holographic storage medium; and a volumetric optical storage medium, such as, a multi-photon absorption storage format. In other embodiments, the optical article may also include an identification card, a passport, a payment card, a driver's license, a personal information card, or any other documents or devices, which employ an optical data layer for data storage.

In one embodiment, the optical article further comprises a wireless activation tag (also referred to as WPFT, wirelessly-powered flexible tag) which is operatively coupled to the thermochromic coating composition. The thermochromic coating composition is one part of an anti-theft system designed to prevent the unauthorized use of the optical article, designed to work in combination with additional components of the anti-theft system such as a removable wireless activation tag. Further details of the use of tags with optical articles as described herein can be found in U.S. patent application Ser. No. 11/567,271, filed Dec. 6, 2006.

In another embodiment, the optical article further comprises a microheater, resistor, or resistive heating element in thermal contact with the thermochromic coating composition. Further details of the use of microheater, resistor, or resistive heating element with optical articles as described herein can be found in U.S. patent application Ser. No. 11/567,271, filed Dec. 6, 2006.

Alternatively, the heating element may be in electrical communication with the electrical circuitry located in the packaging of the optical article. In one embodiment, the electrical circuitry may draw upon a source for electrical energy such as a battery or charged capacitor in the packaging. At the POS the electrical circuitry in the packaging may then form electrical connections with the activation source, thereby providing the electrical energy for heating the thermochromic coating. In certain embodiments, the packaging and/or tag comprises a battery configured to supply electrical energy to the thermochromic coating, wherein the battery is stimulated by the external stimulus. In these embodiments, the battery is not directly stimulated by the external stimulus, but rather provides power to heat the thermally responsive layer when the RF circuit is externally stimulated

In one embodiment, when the thermochromic ink composition or the thermochromic coating composition is in the first optical state the optical article may be considered to be in a pre-activated state of functionality and when the thermochromic ink composition or the thermochromic coating composition is in the second optical state the optical article may be considered to be in an activated state of functionality. In one embodiment, the difference in the percent optical reflectivity or the percent transmittance of at least one portion of the optical data layer in the “pre-activated state” of functionality and the “activated” state of functionality is at least about 10 percent. In another embodiment, the difference in the percent optical reflectivity or the percent transmittance of at least one portion of the optical data layer in the “pre-activated state” of functionality and the “activated” state of functionality is at least about 15 percent. In yet another embodiment, the difference in the percent optical reflectivity or the percent transmittance of at least one portion of the optical data layer in the “pre-activated state” of functionality and the “activated” state of functionality is at least about 20 percent.

In various embodiments of the invention, the optical article comprising the thermochromic coating composition may be transformed from a “pre-activated” state of functionality to an “activated” state of functionality. Conversion from the “pre-activated” state of functionality to the “activated” state of functionality is achieved by the activation of the thermochromic coating composition, which is deposited in or on the optical article, such that the thermochromic coating composition is in optical communication with the optical data layer. As used herein, the term optical communication refers to transmission and reception of light by optical devices. The thermochromic coating composition is activated by interacting with one or more thermal stimuli, applied either directly or remotely to the thermochromic coating composition. In one embodiment, the thermochromic coating composition is capable of irreversibly altering the state of functionality of the optical article. In the “pre-activated” state, at least one portion of the data from the optical data layer is unreadable by the incident laser of an optical data reader device, however, this same portion of data can be read from the optical data layer in the “activated” state of functionality.

The thermochromic ink composition and/or the thermochromic coating composition disclosed herein are capable of transforming from a first optical state to a second optical state upon exposure to either a direct or a remote thermal stimulus. As used herein, the term “direct” when used with respect to the application of the thermal stimulus to the thermochromic ink composition and/or the thermochromic coating composition refers to an embodiment wherein the thermal stimulus is in “direct” physical contact with the thermochromic ink composition and/or thermochromic coating composition.

As used herein, the term “remote” when used with respect to the application of the thermal stimulus to the thermochromic ink composition and/or the thermochromic coating composition refers to an embodiment wherein the thermal stimuli is not in “direct” physical contact with the thermochromic ink composition and/or thermochromic coating composition. One example wherein the thermal stimuli is applied remotely to a thermochromic coating composition is an embodiment wherein at least a portion of the thermochromic coating composition is coated with an optically transparent second layer, which serves as a protective coating for the thermochromic coating composition from chemical and/or physical damage, and wherein the application of the thermal stimuli to the thermochromic coating composition is through the optically transparent second layer. Another example wherein the thermal stimuli is applied remotely to a thermochromic coating composition is an embodiment wherein a ray of light is incident on at least a portion of the thermochromic coating composition and the ray of light generates heat sufficient to transform the thermochromic coating composition from a first optical state to a second optical state.

As used herein, the term “pre-activated” state of functionality refers to a state of functionality of the optical article where the thermochromic coating composition has not yet been exposed to one or more external stimuli, while the “activated” state refers to a state of functionality where the thermochromic coating composition has been exposed to the external stimuli. In one embodiment, the “pre-activated” state comprises at least one thermochromic coating composition which inhibits portions of the optical data layer that are located directly in the optical path of the incident laser of an optical data reader from being read. The activated state comprises a state of the optical article where the optical data layer can be read by the optical data reader as a result of the article being exposed to at least one external stimulus.

In another embodiment, at least one thermochromic coating composition is at least partially transparent to the incident laser of an optical data reader in the pre-activated state, allowing the data on the optical layer located directly in the optical path of the laser to be read. In this embodiment, the thermochromic coating composition at least partially absorbs the laser from the optical data reader in the activated state and prevents the data directly in the optical path of the laser from being read.

The change in the optical properties of the thermochromic coating composition upon activation can occur using at least two approaches. In the first approach, the thermochromic coating composition at least partially absorbs the incident laser from an optical data reader in the “pre-activated” state, and the data directly in the optical path of the laser cannot be read. In this instance, the content stored in the optical article below the thermochromic coating is unplayable. Upon converting the optical article to the “activated” state using an external stimulus, the thermochromic coating composition is at least partially transparent to the incident laser from an optical data reader, the data directly in the optical path of the laser can be read, and the content below the thermochromic optical coating is playable.

The second approach requires an additional “authoring” component, which allows the disc to be playable or unplayable, depending on whether portions of the data on the optical data layer can be read by the incident laser from an optical data reader. An explanation of the term “authoring” as it relates to an optical article, such as a DVD, can be found in “DVD Authoring and Production”, by Ralph LaBarge, CMP Books, 2001. In this second approach, the thermochromic coating composition is at least partially transparent to the incident laser from an optical data reader in the “pre-activated” state, and the data directly in the optical path of the laser can be read. In this instance, the optical article is “authored” unplayable. Upon converting the optical article to the “activated” state using an external stimulus, the incident laser from the optical data reader thermochromic coating composition is at least partially absorbed by thermochromic coating composition, the data directly in the optical path of the laser cannot be read, and the disc is “authored” playable.

In one embodiment the term “damaged” state refers to a state of functionality of the optical article where the optical article has undergone a physical modification such as, but not limited to, a scratch, a dimple, or a physical modification in or on the optical article. The “damaged” state may be a result of improper activation of one or more optical-state change materials in or on the optical article. In the “damaged” state at least a portion of the optical data layer cannot be read by the laser of an optical data reader as a result of significant absorbance of the laser by at least a portion of at least one thermochromic optical-state change material. In contrast to the “activated” state, where all the thermochromic coating composition is sufficiently transparent to the laser from the optical data reader, in the “damaged” state at least a portion of the thermochromic coating composition absorbs at least a portion of the wavelength of the incident laser from the optical data reader and prevents the data directly in the optical path of the laser from being read.

In various embodiments, the article comprises one or more spots of the thermochromic coating composition wherein the spots have a first surface and a second surface. In embodiments where two or more spots are employed, each of the spots may be located at a unique location on the article, designed to function in concert as part of the anti-theft system. In one embodiment, at least two spots are in direct physical contact with each other, (i.e., juxtaposed next to each other). Suitable examples of two spots in direct physical contact include, but are not limited to, concentric lines, concentric arcs, concentric spots, patterned lines, patterned arcs, patterned spots, lines or arcs which are positioned end-to-end, or any combination thereof. In one embodiment, the article comprises at least two spots, wherein at least one spot is not transparent to the incident laser of an optical data reader in the “pre-activated” state. If the article is converted from the “pre-activated” state to the “damaged” state as a result of improper activation, the optical properties of each of the spots are designed to change irreversibly such that at least a portion of at least one of the spots absorbs the laser from the optical data reader, and prevents the data directly in the optical path of the laser from being read.

For example, in one embodiment the optical article comprises two spots, a first spot having an optical absorbance greater than about 0.35 in the “pre-activated” state (a spot with absorbance of 0.35 at the wavelength of the laser partially absorbs the laser such that the reflectivity of the optical article is about 45 percent), and the second spot having an optical absorbance less than about 0.35 in the “pre-activated” state. Upon activation, the optical article is converted to the “activated” state where the optical properties of only the first spot is transformed such that the optical absorbance is less than about 0.35. Upon improper activation, the optical article is converted to a “damaged” state where the optical absorbance of the first spot is transformed such that the optical absorbance is less than about 0.35 and the optical absorbance of the second spot is transformed such that the optical absorbance is greater than about 0.35. In one embodiment the transformation of the optical absorbance of either a single spot, or a combination of spots, can be combined with an additional “authoring” component, which is described above, to create a mechanism for distinguishing between a “pre-activated” state and an “activated” state.

The change in optical properties of the thermochromic coating composition in or on optical article upon exposure to a thermal stimulus (e.g., from the activation system) can appear in any manner that results in the optical data reader system receiving a substantial change in the amount of optical reflectivity detected. For example, where the thermochromic coating composition is initially opaque and becomes more transparent upon exposure to an external stimulus, there should be a substantial increase in the amount of light reflected off of the data storage layer and transmitted to the optical reader device. For example, most blue materials typically change (reduce) the amount of reflected incident radiation detected by means of selective absorption at one or more given wavelengths of interest (e.g., 650 nm) corresponding to the type of optical data reader system.

In another example, where the optical article includes a DVD, in one embodiment, the “pre-activated” state of functionality is characterized by an optical reflectivity of at least a portion of the optical article being substantially less than about 45 percent. In another embodiment, the “pre-activated” state of functionality is characterized by an optical reflectivity of at least a portion of the optical article being less than about 20 percent. In yet another embodiment, the “pre-activated” state of functionality is characterized by an optical reflectivity of at least a portion of the optical article being less than about 10 percent. In these embodiments, the data in the optical data layer of the optical storage medium is not readable in the pre-activated state. It should be appreciated that any portion of the optical article that has an optical reflectivity of less than about 45 percent may not be readable by the optical data reader of a typical DVD player. Furthermore, the activated state is characterized by an optical reflectivity of that same portion of the optical article being substantially more than about 45 percent.

It should be appreciated that there are analogous predetermined values of optical properties for activating different optical articles. For example, the specified (as per ECMA-267) minimum optical reflectivity for DVD-9 (dual layer) media is in a range from about 18 percent to about 30 percent and is dependent upon the layer (0 or 1).

The thermochromic coating composition may render the optical article partially or completely unreadable in the pre-activated state of functionality of the optical article. In the pre-activated state, the thermochromic coating composition may act as a read-inhibit layer by preventing the incident laser of an optical data reader from reaching at least a portion of the optical data layer and reading the data on the optical data layer. For example, the thermochromic coating composition may absorb a major portion of the incident laser light, thereby preventing it from reaching the optical data layer to read the data.

Upon interaction with one or more external stimuli, the optical absorbance of the thermochromic coating composition may be altered to change the functionality of the optical article from the pre-activated state to the activated state. For example, in the pre-activated state, the thermochromic coating composition may render the optical article unreadable by absorbing a portion of the wavelength from the incident laser of an optical data reader. However, upon interaction with an external stimulus the thermochromic coating composition becomes transparent to the wavelength of the laser used to read the optical article, thereby making the portion of the optical data layer which is located directly in the optical path of the laser from the optical data reader readable in the activated state. Suitable examples of external stimuli which can generate a thermal stimulus may include a laser, infrared radiation, thermal energy, X-rays, gamma rays, microwaves, visible light, ultraviolet light, ultrasound waves, radio frequency waves, microwaves, electrical energy, chemical energy, magnetic energy, or combinations thereof which generate a thermal stimulus. The interaction of the external stimulus with the optical article may include continuous, discontinuous, or pulsed forms of the external stimulus.

In various embodiments, the thermochromic coating composition may be deposited in a discrete area on the optical article, such that at least one spot, at least one line, at least one radial arc, at least one patch, a continuous layer, or a patterned layer extends across at least a portion of the optical article. One or more thermochromic coating compositions may be deposited on the optical article in various forms, such as a discrete portion, a continuous film, or a patterned film. During authorization, the thermochromic coating composition may be heated in a continuous, discontinuous or pulsed form. Sources of heat include, but are not limited to infrared lamps, laser radiation, resistive heating elements or inductive heating elements, which may be in direct contact with the thermochromic coating composition or may be remote to the thermochromic coating composition so as to radiate or conduct heat to at least a portion of the thermochromic coating composition to render a change in the optical absorbance of the thermochromic coating composition such that the incident laser may pass through the thermochromic coating composition and reach the optical data layer. For example, the heat may change the color of the thermochromic coating composition to make it transparent to the laser.

Alternatively, instead of being deposited on the surface of the optical article, the thermochromic coating composition may be deposited inside the structure of the optical article. In optical storage articles, the thermochromic coating composition may be deposited in the substrate on which the optical data layer is deposited. In such an embodiment, the thermochromic coating composition may be mixed with the substrate material of the optical article. In alternate embodiments, the thermochromic coating composition may be deposited between the layers of the optical article, or may be deposited within the layers of the optical article. For example, the thermochromic coating composition may be incorporated in the UV curable adhesive of the bonding (spacer) layer. It should be appreciated that these thermochromic coating compositions should be thermally stable to withstand the molding temperatures of the optical article. Also, these thermochromic coating compositions may preferably absorb the wavelength of the laser in one of the activated, or the pre-activated state of the optical article. Upon interaction with external stimulus, the thermochromic coating composition present inside the substrate changes color. As a result, the substrate may become transparent to the laser light, thereby facilitating the transmittance of laser light through the substrate and making the optical article readable.

In some embodiments, at least a portion of the thermochromic coating composition is coated with an optically transparent second layer. The optically transparent second layer serves as a protective coating for the thermochromic coating composition from chemical and/or physical damage. The optically transparent second layer may contain cross-linkable materials that can be cured using ultraviolet (UV) light or heat. Furthermore, the optically transparent second layer may be a scratch resistant coating. For example, the optically transparent second layer may include, but is not limited to, a matrix consisting of cross-linkable acrylates, silicones, and nano or micron silicate particles. Suitable examples of an optically transparent second layer can be found in U.S. Pat. No. 5,990,188.

In still another embodiment, of the present invention is provided a method for transforming a thermochromic ink composition or a thermochromic coating composition from a first percent optical transmittance to a second percent optical transmittance, the method comprising the step of exposing the thermochromic ink composition or the thermochromic coating to a time-dependent thermal stimulus.

In at least one embodiment, the method comprises generating a time dependent thermal stimulus in at least two steps. In the first step, the external stimulus delivers power at a first level for a short time component, characterized by a very high rate of change of temperature (i.e. dT/dt) to rapidly achieve a desired temperature. Subsequently, in the second step, the external stimulus delivers power at a second level, which is lower than the first level and is characterized by a dT/dt which is essentially zero to maintain the desired temperature for a second time component.

In another embodiment, the invention provides a method for changing the functionality of an optical article, comprising the steps of attaching a heating element to the optical article such that the heating element is in thermal contact with a thermochromic coating composition, sending an electrical signal from an activation device to the heating element, applying a time-dependent electrical current to the heating element, transferring heat from the heating element to the thermochromic coating composition, resulting in a change in optical transmittance of the thermochromic coating composition, and transforming the optical article from a pre-activated state of functionality to an activated state of functionality, and removing the heating element from the optical article.

### EXAMPLES

### Example 1 Provides a Thermochromic Ink Composition and a Method for Preparing the Same

A 20 milliliters vial was charged with 5 grams of dipropylene glycol methyl ether, 5 grams of diacetone alcohol, and 400 milligrams of polymethylmethacrylate (PMMA) with a weight average molecular weight of about 37,000 as measured using gel permeation chromatography using polystyrene standards. The solution was stirred at 70° C. for about 1 hour until the polymer was completely dissolved. The solution was then cooled to room temperature (about 22° C.), and 225 milligrams of bromocresol green-sodium salt was completely dissolved to yield a deep green homogeneous solution. The pH of the green solution was adjusted to below about 4. by dissolving 70 milligrams of 1,8-diaminonaphthalene into it, which turned the solution deep blue. Finally, 400 milligrams of ammonium hexafluoroantimonate (i.e. XC-7231, obtained from King Industries, Inc. (Norwalk, Conn.)), and 145 milligrams of 4,4′-biphenol were completely dissolved in the blue solution and the resulting composition was stirred for an additional 12 hours at room temperature (about 22° C.). The viscosity of the thermochromic ink composition was measured to be 10 cPs, using a Brookfield Viscometer and a stainless steel spindle.

### Example 2 Provides a Thermochromic Ink Composition and a Method for Preparing the Same

The thermochromic ink formulation was prepared analogously to example 1, except a polymethylmethacrylate of about one-million weight average molecular weight was used. The viscosity of the thermochromic ink composition was measured to be 45 cPs, using a Brookfield Viscometer and a stainless steel spindle.

### Example 3 Provides a Thermochromic Coating Prepared Using the Thermochromic Ink Composition of Example 1

The thermochromic coating was prepared by spin coating a 250 micro liter sample of the ink onto a DVD-5 disc at 4000 RPM for 5 seconds to produce a deep blue coating having a thickness of about 0.5 microns. The coating was allowed to dry at room temperature (about 22° C.) for about 12 hours. The coating was then heated to a temperature of about 100° C. for about 180 seconds. The absorbance of the thermochromic coating, at 650 nm, was measured using a fiber optic UV-Vis spectrometer (Ocean Optics Inc.) in reflectance mode. The recorded absorbance values before and after heating for 5 replicate measurements are listed in Table 1.

TABLE 1

Absorbance

| Replicat | Before Heating | After Heating |
|---|---|---|
| 1 | 0.51 | 0.35 |
| 2 | 0.50 | 0.34 |
| 3 | 0.49 | 0.33 |
| 4 | 0.47 | 0.33 |
| 5 | 0.47 | 0.32 |

### Example 4 Provides a Method for Heating the Thermochromic Coating Using a Multi-Step Voltage Profile

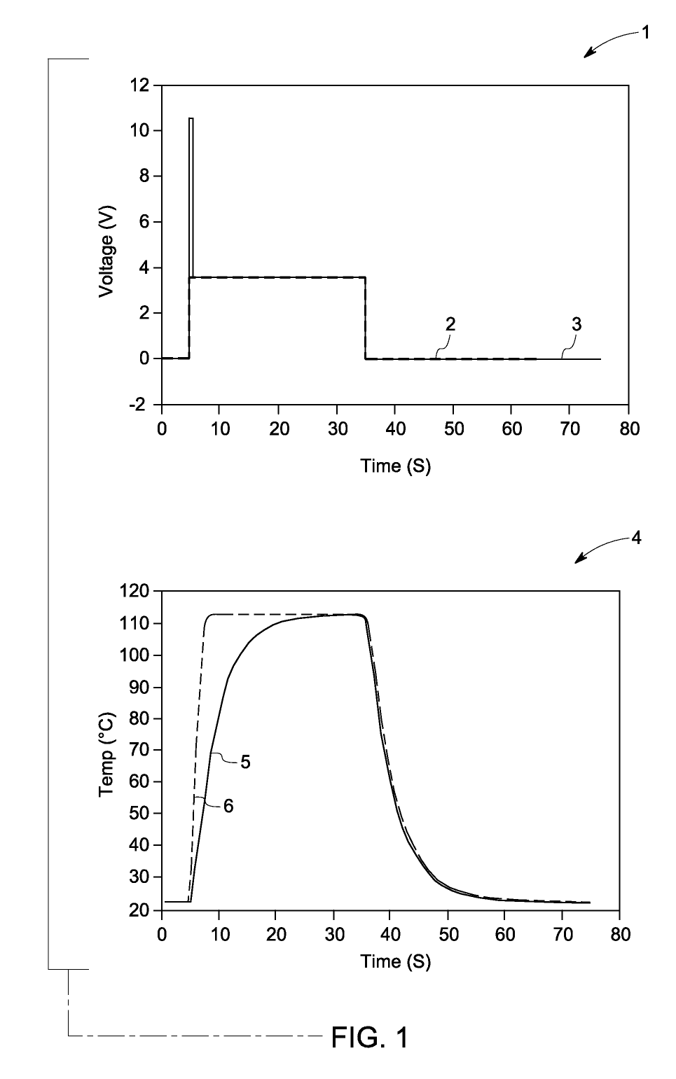

A heater comprising a 49.9-ohm surface mount resistor with a coating of thermally conductive RTV silicon (Chromerics 1641) was powered by a DC power supply controlled by a computer and measured by a thermocouple attached to the surface of the RTV coating. The voltage applied to the heater was initially set to 10.5 V for 0.5 s and then 3.5 V for 30 s. The heater reached a constant temperature of approximately 110° C. after approximately 2 seconds. Referring to FIG. 1 the voltage versus time profile (1) shows a voltage curve (3) which indicates the two step voltage application described in Example 4. The corresponding temperature profile (4) shows a temperature curve (6) which indicates that when a multi-step voltage profile is used the heater requires less time i.e., 2 seconds to reach a desired temperature i.e., 110° C.

### Comparative Example 1 Provides a Method for Heating the Thermochromic Coating Using a Single Voltage Profile

A heater comprising a 49.9-ohm surface mount resistor with a coating of thermally conductive RTV silicon (Chromerics 1641) was powered by a DC power supply controlled by a computer by LabView as measured by a thermocouple attached to the surface of the RTV coating. The voltage applied to the heater was set to a constant voltage of 3.5 V for 30 seconds. The heater reached a constant temperature of approximately 110° C. after approximately 20 seconds. Referring to FIG. 1 the voltage versus time profile (1) shows a voltage curve (2) which indicates the one step voltage application. The corresponding temperature profile (4) shows a temperature curve (5) which indicates that when a single voltage profile is used the heater requires more time i.e., 20 seconds to reach a desired temperature i.e., 110° C.

### Example 5 Provides a Method for Heating the Thermochromic Coating Using a Multi-Step Voltage Profile

A heater made from OhmegaPly® NiP materials with a sheet resistivity of 25 ohms/square patterned into a rectangle of approximately 8 millimeter×4 millimeter and having a nominal value to 61.1+/−2.4 ohms was used to heat a spot of thermochromic coating deposited onto the surface of a DVD-9 by inkjet printing the ink described in Example 1 using a Dimatrix DMP printer. The heater was secured to the DVD surface by a piece of polyimide tape coated with a pressure sensitive adhesive, and connected to the programmable DC power supply. A voltage (power) of 14.3 Volts (3.35 Watt) for 1 second, and 8.9 Volts (1.30 Watts) for 1 second, and 7.0 Volts (0.8 Watts) for 8 seconds was delivered to the heater. The reflectivity of the DVD where the thermochromic spot was coated was measured and was found to be greater than about 30 percent.

### Example 6 Provides the Variation in Viscosities of the Ink Composition with the Change in Amount and Molecular Weight of Polymer Employed

Six thermochromic ink compositions were prepared in the same manner as described in Example 1 above, except with varying amounts of weight percent of PMMA polymer and varying weight average molecular weights (Mw) of the PMMA polymer. The Mw were measured using gel permeation chromatography using polystyrene standards. The amount of PMMA, Mw of PMMA and the viscosities of the resultant ink compositions are listed in Table 2 below.

TABLE 2

| PMMA | | |
|---|---|---|
| Weight | PMMA | Viscocity |
| percent | Mw | (cPs) |
| 5 | 15,000 | 5.2 |
| 5 | 35,000 | 6.5 |
| 5 | 37,000 | 7 |
| 7 | 15,000 | 6.4 |
| 7 | 35,000 | 9.4 |
| 7 | 37,000 | 10 |

### Example 7 Provides a Thermochromic Ink Comprising a pH-Sensitive Dye and a Non-pH-Sensitive Dye and a Method for Preparing the Same

A vial was charged with 5 grams of dipropylene glycol methyl ether, 5 grams of diacetone alcohol, and 530 milligrams of PMMA with a weight average molecular weight of about 37,000 as measured using gel permeation chromatography using polystyrene standards. The solution was stirred at 70° C. for about 1 hour until the polymer was completely dissolved. The solution was then cooled to room temperature (about 22° C.), and 50 milligrams of 1,1′-dibutyl-3,3,3′,3′-tetramethylindadicarbocyanine perchlorate (Dye 683, obtained from ORGANICA Feinchemie GmbH Wolfen) and 350 milligrams of bromocresol green-sodium salt (Sigma-Aldrich, St. Louis, Mo.) were completely dissolved to yield a deep green homogeneous solution. The color of the solution was adjusted to a deep blue by dissolving 88 milligrams of dicyclohexylamine (Sigma-Aldrich, St. Louis, Mo.) into it. Then 372 milligrams of ammonium hexafluoroantimonate (i.e., XC-7231, obtained from King Industries, Inc. (Norwalk, Conn.)), and 190 milligrams of 4,4′-biphenol (Sigma-Aldrich, St. Louis, Mo.) were completely dissolved in the blue solution and the resulting composition was stirred for an additional 12 hours at room temperature (about 22° C.). The viscosity of the thermochromic ink composition was measured to be 11 cPs, using a Brookfield Viscometer and a stainless steel spindle.

### Example 8 Provides a Thermochromic Coating Composition Prepared Using the Thermochromic Ink Composition of Example 7

A thermochromic coating composition was prepared by spin coating a 250 microliter sample of the ink onto a DVD-5 disc at 5000 RPM for 30 seconds to produce a deep blue coating. The coating was allowed to dry at room temperature (about 22° C.) for about 12 hours. The coating was then heated to a temperature of about 60° C. for about 18 hours. The absorbance of the thermochromic coating, at 650 nm, was measured using a fiber optic UV-Vis spectrometer (Ocean Optics Inc.) in reflectance mode. The recorded absorbance values before heating was 0.50 and after heating was 0.40. It can be appreciated that the absorbances both before and after heating can be tailored based on the concentration of non-pH-sensitive dye (e.g., 1,1′-dibutyl-3,3,3′,3′-tetramethylindadicarbocyanine perchlorate) and pH-sensitive dye (e.g., bromocresol green).

Another thermochromic coating was prepared by inkjet printing the ink composition of Example 7 onto a DVD-5 disc using a Dimatix DMP inkjet printer to produce a deep blue coating having a thickness of about 0.3 microns. The coating was allowed to dry at room temperature (about 22° C.) for about 12 hours. The coating was then heated to a temperature of about 120° C. for about 10 seconds. The recorded absorbance values before heating was 0.60 and after heating was 0.48.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include some of the described embodiments. Accordingly, the invention is not to be seen as limited by the foregoing description, but is only limited by the scope of the appended claims.

1. A thermochromic ink composition comprising; at least one thermochromic optical-state change material, at least one thermally responsive pH modifier, at least one solvent, and at least one binder material; wherein said ink composition has a viscosity between about 0.1 centipoise and about 10,000 centipoise, and a maximum optical absorbance in a range from about 200 nanometers to about 800 nanometers; and wherein said ink composition is capable of transforming from a first optical state to a second optical state upon exposure to a thermal stimulus.

2. The composition of claim 1, wherein the thermochromic optical-state change material comprises at least one chromic dye.

3. The composition of claim 2, wherein the chromic dye is a triarylmethylene dye.

4. The composition of claim 1, wherein the thermally responsive pH modifier is a thermally responsive Bronsted acid or a thermally responsive Bronsted base.

5. The composition of claim 1, wherein the solvent comprises one or more of a glycol ether solvent, an aromatic hydrocarbon solvent containing at least 7 carbon atoms, an aliphatic hydrocarbon solvent containing at least 6 carbon atoms, a halogenated solvent, an amine based solvent, an amide based solvent, a oxygenated hydrocarbon solvent, or a miscible combination thereof.

6. The composition of claim 1, wherein the binder material comprises one or more of a polymer, an oligomer, a polymeric precursor, or a polymerizable monomer.

7. The composition of claim 1, wherein the binder material comprises one or more of a polyolefin, a polyester, a polyamide, a polyacrylate, a polymethacrylate, a polyvinylchloride, a polycarbonate, a polysulfone, a polysiloxane, a polyetherimide, a polyetherketone, or a copolymer thereof.

8. The composition of claim 1, wherein the transformation from the first optical state to the second optical state is a bistable transformation.

9. The composition of claim 1, wherein the thermochromic ink composition is transformed from the first optical state to the second optical state in a temperature range from about 25° C. to about 200° C.

10. The composition of claim 1, wherein the difference in an optical reflectivity of the thermochromic ink composition between the first optical state and the second optical state is at least 10 percent.

11. The composition of claim 1, wherein the difference in the transmittance of the thermochromic ink composition material between the first optical state and the second optical state is at least 10 percent.

12. The composition of claim 1, further comprising a non-thermally responsive pH modifier.

13. The composition of claim 1, further comprising an anti-photobleaching agent.

14. A thermochromic coating deposited using a thermochromic ink composition, wherein the coating comprises at least one thermochromic optical-state change material, at least one thermally responsive pH modifier, and at least one binder material, wherein said coating is essentially free of solvent, wherein said thermochromic coating composition has a maximum optical absorbance in a range from about 200 nanometers to about 800 nanometers, and wherein said thermochromic coating composition is capable of transforming from a first optical state to a second optical state upon exposure to a thermal stimulus.

15. The coating of claim 14, wherein the thermochromic optical-state change material comprises at least one chromic dye.

16. The coating of claim 15, wherein the chromic dye is a triarylmethylene dye.

17. The coating of claim 14, wherein the thermally responsive pH modifier is a thermally responsive Bronsted acid or a thermally responsive Bronsted base.

18. The coating of claim 14, wherein the binder material comprises one or more of a polymer, an oligomer, a polymeric precursor, or a polymerizable monomer.

19. The coating of claim 14, wherein the binder material comprises one or more of a polyolefin, a polyester, a polyamide, a polyacrylate, a polymethacrylate, a polyvinylchloride, a polycarbonate, a polysulfone, a polysiloxane, a polyetherimide, a polyetherketone, or a copolymer thereof.

20. The coating of claim 14, wherein the transformation from the first optical state to the second optical state is a bistable transformation.

21. The coating of claim 14, wherein the thermochromic coating composition is transformed from the first optical state to the second optical state in a temperature range from about 25° C. to about 200° C.

22. The coating of claim 14, wherein the difference in an optical reflectivity of the thermochromic coating composition between the first optical state and the second optical state is at least 10 percent.

23. The coating of claim 14, wherein the difference in the transmittance of the thermochromic coating composition between the first optical state and the second optical state is at least 10 percent.

24. The coating of claim 14, further comprising a non-thermally responsive pH modifier.

25. The coating of claim 14, further comprising an anti-photobleaching agent.

26. An article comprising a thermochromic coating composition deposited in or deposited on said article, wherein said thermochromic coating composition comprises at least one thermochromic optical-state change material, at least one thermally responsive pH modifier, and at least one binder material, wherein said thermochromic coating composition is essentially free of solvent, wherein said thermochromic coating composition has an optical absorbance in a range from about 200 nanometers to about 800 nanometers, and wherein said thermochromic coating is capable of transforming from a first optical state to a second optical state upon exposure to a thermal stimulus.

27. The article of claim 26, is an optical article selected from the group consisting of a CD, a DVD, a HD-DVD, a blu-ray disc, a near field optical storage disc, a holographic storage medium, an identification card, a passport, a payment card, a driving license, or a personal information card.

28. The optical article of claim 27, wherein the composition is deposited in a discrete area of the optical article, a continuous layer extending across a portion of the optical article, or a patterned layer extending across a portion of the optical article.

29. The article of claim 26, further comprising a second layer deposited on the thermochromic coating composition.

30. The optical article of claim 26, further comprising a wirelessly powered flexible tag operatively coupled to the thermochromic coating composition.

31. The optical article of claim 26, further comprising a microheater, resistor, or resistive heating element in thermal contact with the thermochromic coating composition.

32. The optical article of claim 31, further comprising a battery or capacitor that is operatively coupled to the resistive heating element in thermal contact with the thermochromic coating composition.

33. A method for transforming a thermochromic ink composition or a thermochromic coating composition from a first percent optical transmittance to a second percent optical transmittance, said method comprising the step of exposing said thermochromic ink composition or said thermochromic coating composition to a time-dependent thermal stimulus.

34. The method of claim 33, wherein the time-dependent thermal stimulus is generated in at least two different steps.

35. A method for changing the functionality of an optical article, comprising the steps of:
attaching a heating element to the optical article such that the heating element is in thermal contact with a thermochromic coating composition;
sending an electrical signal from an activation device to the heating element;
applying a time-dependent electrical current to the heating element;
transferring heat from the heating element to the thermochromic coating, resulting in a change in optical transmittance of the thermochromic coating composition, and transforming the optical article from a pre-activated state of functionality to an activated state of functionality; and
removing the heating element from the optical article.
